(19) United States
(12) Patent Application Publication
(10) Pub. No.: US 2007/0189345 A1
(43) Pub. Date: Aug. 16, 2007

(54) Apparatus and method for controlling power of laser diode

(75) Inventors: Jong-Jin Ko, Seoul (KR); Otsuka Tatsuhiro, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/592,170

(22) Filed: Nov. 3, 2006

(30) Foreign Application Priority Data
Feb. 11, 2006 (KR) 2006-13320

(51) Int. Cl. H01S 3/13; H01S 3/00

(52) U.S. Cl. 372/29.021; 372/38.01

(57) ABSTRACT

An apparatus and method for controlling power of a laser diode (LD) are provided, which allow the power of the laser diode (LD) affecting a performance of an optical recording apparatus to be constantly maintained at an optimum state, regardless of a variation in temperature. The method for controlling power of a laser diode (LD) used for an optical recording apparatus to record data in an optical recording device comprises: a) sampling the LD's power generated when data is recorded; and b) compensating for a variation of the LD's power changed according to sampling locations.

### CROSS-REFERENCE TO RELATED APPLICATIONS

This application claims all benefits accruing under 35 U.S.C. §119 from Korean Patent Application No. 2006-0013320, filed on Feb. 11, 2006 in the Korean Intellectual Property Office, the disclosure of which is incorporated herein by reference.

### BACKGROUND OF THE INVENTION

1. Field of the Invention

The present invention relates to an optical recording apparatus for optically recording/reproducing data, and more particularly, to an apparatus and method for controlling power of a laser diode, for optimal performance.

2. Related Art

In recent times, with the increasing development of video- and audio-media, there have recently been developed a variety of recording media capable of recording/storing high-quality video data and high-quality audio data for a long period of time, for example, DVD-based optical discs, i.e., DVD±R/RW (Digital Versatile Disc Recordable/Rewritable) and DVD-RAM (DVD Random Access Memory), etc., such that the above-mentioned DVD-based optical discs are made commercially available. As storage capacity of the DVD gradually reaches the uppermost limit, there have recently been developed new high-density optical discs (e.g., Blu-ray Disc (BD) Recordable/ Rewritable or HD-DVD (High Density DVD) having high capacity of several tens of Gbytes or more. In addition, other high-density recording media, for example, MODD (Magnetic Optical Disc Drive) and CD-R/RW, etc., may also be used if required.

A laser diode (LD) is typically utilized by an optical recording apparatus to record data on an optical disc. The optical recording apparatus operates the LD to apply a high-power laser beam to the surface of the optical disc, such that data can be recorded in the optical disc. In more detail, data can be recorded on the optical disc, only when physical characteristics of a record layer contained in the optical disc are changed, and the physical characteristics are changed by the high-power laser beam, such that the high-power laser beam must be applied to the optical recording apparatus by the LD.

In this case, although an optimum recording power for recording data must be constantly maintained to correctly record data, the LD has very weak resistance to temperature, such that the recording medium of the LD varies with temperature at the same drive current. In other words, the higher the temperature, the lower the LD's recording power. In contrast, the lower the temperature, the higher the LD's recording power. As a result of a variation in temperature, a record performance of the optical recording apparatus may be deteriorated. Worse, it may be impossible to record data on the optical disc.

Therefore, in order to solve the above-mentioned problems, a constant recording power must be generated at an optimum state irrespective of a variation in temperature when the laser diode (LD) is installed in an optical recording apparatus. Several technologies, which have been developed to address the above-mentioned problems, include an Automatic Laser Diode Power Control (ALPC) function or an Automatic Power Control (APC) function. The ALPC function or the APC function must be effectively implemented within a short period of time.

Generally, the APLC function monitors the LD's power using an additional photo-diode (PD) to control a variation in the LD's power to be fed back, such that the feed-back is then used to maintain the LD's power constantly.

FIG. 1 is a block diagram illustrating a typical laser diode (LD) power control apparatus which implements the ALPC function to control power of a laser diode (LD). Referring to FIG. 1, the laser diode (LD) power control apparatus comprises a photo-detector (PD) for detecting an output power of an output optical signal of the laser diode (LD), and converting the detected power into a current signal; an IN converter 1 for converting the current signal detected by the PD into a voltage signal, and outputting a current power having been fed back; one or more comparators 3A-3B for comparing the current power of the LD generated from the I/V converter 1 with a desired reference power; one or more up/down counters 5A-5D operated by the comparison result, for determining the increase or reduction of the current signal; one or more digital-to-analog converters (DACs) 7A-7D for converting an output signal of the up/down counters 5A-5D into an analog signal, and an LD drive 9 for driving the LD to output a current signal (i.e., a recording power) corresponding to a record control level according to an output value of the DACs 7A-7D.

Operations of the above-mentioned laser-diode (LD) power control device will be described in detail herein below.

If an output power of an optical signal emitted from the LD is detected by the PD and the detected output power is converted into a current signal, the current signal detected by the PD is converted into a voltage signal via the IN converter 1, and a current power having been fed back is applied to a selected comparator, for example, comparator 3A. The comparator 3A compares the current power having been fed back with a desired reference power, and outputs the result of the comparison to the up/down counter, for example, up/down counters 5A-5B. As a result, the current signal generated from the PD according to the power level is applied to the up/down counters 5A-5B, via the IN converter 1 and the comparator 3A.

The output signal of the comparator 3A is applied to an up/down control terminal of the up/down counters 5A-5B, such that it is increased or reduced according to the output result of the comparator 3A. Individual output signals of the up/down counters 5A-5B are converted into analog signals, via the DAC, for example, DACs 7A-7B, respectively, such that the analog signals are applied to the LD drive 9.

Therefore, the LD drive 9 outputs a current signal (i.e., a recording power) corresponding to a record control level to the LD according to a control signal for controlling individual power levels and individual powers, such that the LD is driven.

However, the above-mentioned laser-diode power control device, as shown in FIG. 1, compares a reference power with the fed-back current power using one or more comparators, such that it can control the recording power of the LD according to the result of the comparison. The laser-diode power control device operates one or more up/down counters according to the result of the comparison, and determines the increase or reduction of the current signal, such that there is a limitation in a power control speed and a control range.

As a result, there is a disadvantage in that the laser-diode (LD) power control device is unable to effectively cope with high-speed and high-capacity optical recording apparatus. In addition, such a laser-diode power control device cannot compensate for a desired power level during a sampling operation. As a result, the laser-diode (LD) power control device, as shown in FIG. 1, cannot quickly cope with the LD's output signal varying with temperature, and cannot acquire a correct power level.

### SUMMARY OF THE INVENTION

Several aspects and example embodiments of the present invention provide an apparatus and method for controlling power of a laser diode (LD), which allows the power of the laser diode (LD) affecting a performance of an optical recording apparatus to be constantly maintained at an optimum state, irrespective of a variation in temperature.

It is another aspect of the invention to provide an apparatus and method for controlling the power of the laser diode (LD), which compensates for an LD power at a sampling time, and constantly maintains the LD power output varying with temperature within a short period of time.

It is still another aspect of the invention to provide an apparatus and method for controlling the power of the laser diode (LD), which compensates for a desired power level at a sampling time, and acquires a correct power level.

Additional aspects and/or advantages of the invention will be set forth in part in the description which follows and, in part, will be obvious from the description, or may be learned by practice of the invention.

In accordance with an embodiment of the invention, an apparatus for controlling power of a laser diode (LD) used for an optical recording apparatus to record data in an optical recording device is provided with a compensator for sampling the LD's power generated when data is recorded, and compensating for a variation of the LD's power varying with temperature.

According to an aspect of the present invention, the compensator compensates for the LD's power varying with temperature at a sampling moment. Such a compensator samples a first point at which the LD's power is maintained during a predetermined time or over and a second point at which the LD's power is maintained during a time shorter than the predetermined time, such that a difference in power level can be compensated according to sampling locations.

According to an aspect of the present invention, the compensator numerically indicates LD's output characteristics varying with temperature in the form of a linear function, calculates the LD's power, and compensates for a difference in power level at each sampling moment on the basis of the calculated LD's power.

According to an aspect of the present invention, the compensator fixes one of a slope and a y-intercept of a numerical linear function, changes the one other than the fixed one, and calculates the LD's power.

According to another aspect of the present invention, the compensator fixes one of a slope and a y-intercept of a numerical linear function, changes the one other than the fixed one, calculates two values, and calculates the LD's power using an average value of the two values.

In accordance with another embodiment of the present invention, there is provided a method for controlling power of a laser diode (LD) used for an optical recording apparatus to record data in an optical recording device. Such a method comprises: a) sampling the power of a laser diode (LD) generated when data is recorded; and b) compensating for a variation of the power of the LD changed according to sampling locations.

According to an aspect of the present invention, the sampling (a) of the LD's power includes: sampling a first point at which the power of the LD is maintained during a predetermined time or over and a second point at which the LD's power is maintained during a time shorter than the predetermined time.

According to an aspect of the present invention, the compensating (b) of the power of the LD includes: compensating for the power of the LD varying with temperature at a sampling moment.

According to another aspect of the present invention, the compensating (b) of the LD's power includes: b1) numerically indicating output characteristics of a laser diode (LD) varying with temperature in the form of a linear function; b2) calculating the power of the LD varying with temperature on the basis of the numerical linear function; and b3) compensating for a difference in power level at each sampling moment on the basis of the calculated power of the LD.

According to an aspect of the present invention, the calculating (b2) of the power of the LD includes: fixing a slope of the numeral linear function; changing only a y-intercept; and calculating the power of the LD.

According to another aspect of the present invention, the calculating (b2) of the power of the LD includes: fixing a y-intercept of the numeral linear function; changing only a slope; and calculating the power of the LD.

According to an aspect of the present invention, the calculating (b2) of the power of the LD includes: fixing one of a slope and a y-intercept of the numerical linear function; changing the one other than the fixed one; calculating two values; and calculating the power of the LD using an average value of the two values.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram illustrating a conventional laser-diode power control device;

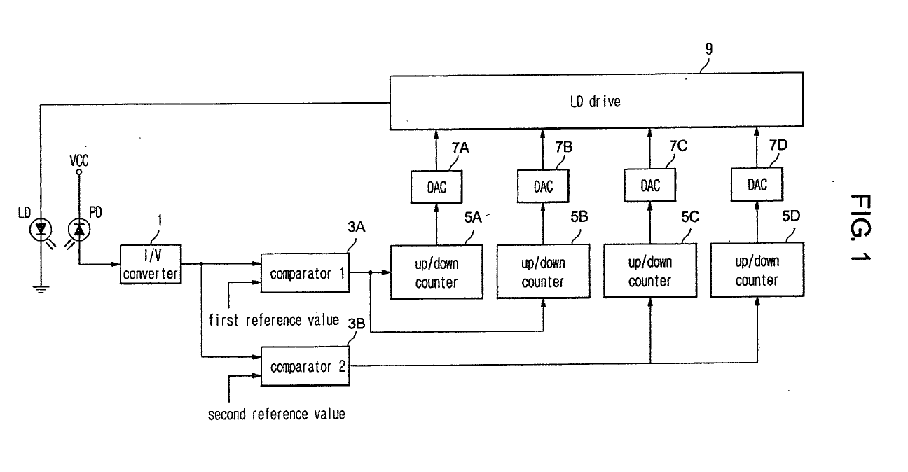

FIG. 2 is a block diagram illustrating a laser-diode power control device according to an embodiment of the present invention;

FIG. 3 shows pulses illustrating a difference in power level according to sampling locations in a data record mode according to an embodiment of the present invention;

FIG. 4 is a graph illustrating optical output characteristics between a current signal of a laser diode (LD) and a real optical output signal of the LD according to a variation in temperature;

FIG. 5 is a graph illustrating the simulation result between a current signal of a laser diode (LD) and an optical output signal of the LD according to a variation in temperature;

FIG. 6 is a graph illustrating a variation in the power of a laser diode (LD) according to a variation in temperature;

FIG. 7 is a graph illustrating a variation in the LD's power according to a variation in temperature when the slope α shown in FIG. 6 is fixed;

FIG. 8 is a graph illustrating a variation in the LD's power according to a variation in temperature when a y-intercept β shown in FIG. 6 is fixed;

FIG. 9 is a graph illustrating a process for searching for an average value of the LD power variation according to a temperature variation acquired when one of the slope a and the y-intercept β shown in FIG. 6 is fixed; and

FIG. 10 is a graph illustrating the simulation result of the process for searching for an average value of the power variation of a laser diode (LD) according to a temperature variation acquired when one of the slope α and the y-intercept β shown in FIG. 6 is fixed.

### DETAILED DESCRIPTION OF THE EMBODIMENTS

Reference will now be made in detail to the embodiments of the present invention, examples of which are illustrated in the accompanying drawings, wherein like reference numerals refer to like elements throughout. The embodiments are described below to explain the present invention by referring to the figures.

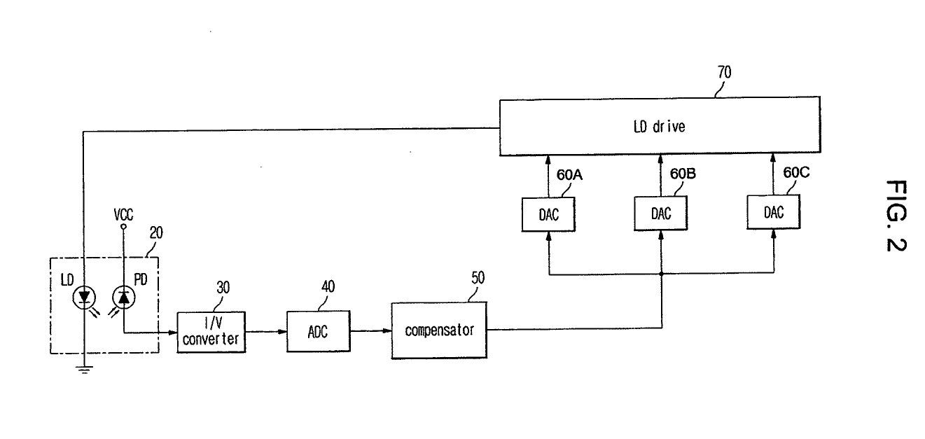

FIG. 2 is a block diagram illustrating a laser-diode (LD) power control device according to an embodiment of the present invention. Referring to FIG. 2, the LD power control device according to the present invention includes an optical pickup unit 20, an I/V converter 30, an analog-to-digital converter (ADC) 40, a compensator 50, one or more digital-to-analog converters (DACs) 60A-60C, and an LD drive 70.

The optical pickup unit 20 applies a predetermined optical signal to a recordable optical disc, and records data on the optical disc. The optical pickup unit 20 includes: a laser diode (LD) for applying an optical signal having a recording power corresponding to a predetermined record control level (i.e., predetermined current capacity) to the optical disc; and a photo-detector (PD) for detecting an output power of the optical signal emitted from the LD, and converting the detected power into a current signal.

The I/V converter 30 converts the current signal detected by the PD into a voltage signal, and outputs a value corresponding to a current recording power of the LD. The ADC 40 receives analog input data from the IN converter 30, and converts the analog data into digital data.

The compensator 50 compensates for the LD power although there is a variation in temperature when data is recorded in the optical disc, such that the compensator 50 can constantly maintain the record power of the LD at an optimum state irrespective of the temperature variation. In more detail, the compensator 50 compensates for a desired power level at a sampling time, such that it can quickly implement the LD's power variation affected by the temperature variation within a short period of time.

The compensator 50 calculates the power variation of the LD according to the temperature variation, and compensates for a voltage difference expected at each instantaneous sampling time, so as to acquire a correct power level.

The one or more DACs 60 convert the value calculated by the compensator 50 into analog data.

The LD drive 70 operates the LD to generate a current signal (i.e., a recording power) corresponding to the record control level. In order to constantly maintain the recording power of the LD, the higher then temperature, the higher the current signal applied to the LD. Likewise, the less the temperature, the less the current signal applied to the LD.

Operations and effects of an apparatus and method for controlling the LD power will be described herein below.

Referring to FIG. 2, if an output power of the optical signal emitted from the LD is detected by the PD and is then converted into a current signal, the current signal is converted into a voltage signal via the I/V converter 30, and is then applied to the ADC 40.

Therefore, the ADC 40 converts an analog input signal of the IN converter 30 into a digital signal, and applies individual momentary conversion values to the compensator 50.

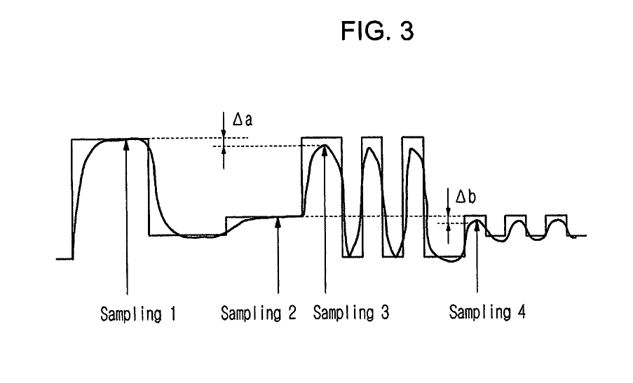

FIG. 3 shows pulses illustrating a difference in power level according to sampling locations in a data record mode according to an embodiment of the present invention. Referring to FIG. 3, there is a difference Δa in the sampling values at the sampling points #1 and #2 spaced apart from each other by a considerably long period of time, and there is a difference Δb in the sampling values at the sampling points #3 and #4 spaced apart from each other by a short period of time. The compensator 50 compensates for the differences Δa and Δb. In more detail, the compensator 50 compensates for a voltage difference expected at each momentary sampling time.

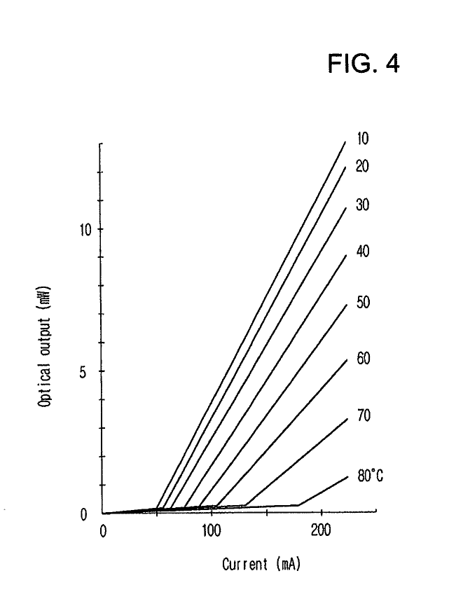

FIG. 4 is a graph illustrating optical output characteristics between a current signal of a laser diode (LD) and a real optical output signal of the LD according to a variation in temperature. As can be seen from FIG. 4, the LD's output power (measured in “mW”) is changed at the same drive current (measured in “mA”) according to a variation in temperature, for example, from 10° C. to 80° C.

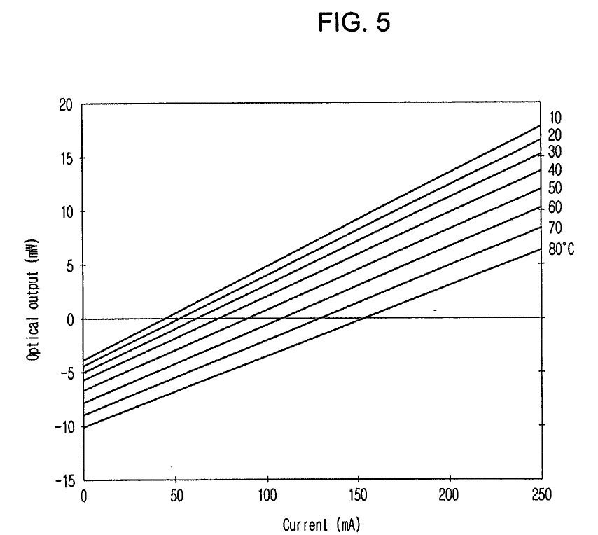

FIG. 5 is a graph illustrating the simulation result between a current signal of a laser diode (LD) and an optical output signal of the LD according to a variation in temperature. In more detail, FIG. 5 shows a linear function of the graph shown in FIG. 4. In this case, the slope and the y-intercept of the linear function are changed according to LD categories.

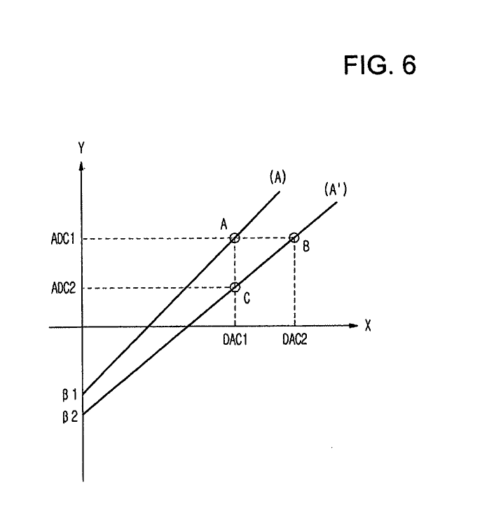

In this manner, if the power variation of the LD associated with a variation of the current signal-to-the optical output signal is represented by a variation of DAC value-to-ADC value, the graph of FIG. 6 can be acquired.

FIG. 6 is a graph illustrating a variation in the power of a laser diode (LD) according to a variation in temperature. Provided that the laser diode (LD) is operated as shown in the graph (A), the following equation #1 can be acquired.
Y=αX−β [Equation #1]
wherein α is a slope, and β is a y-intercept.

In more detail, according to the LD's output characteristics, as the temperature increases, the slope α is reduced and the y-intercept |β| increases as can be seen from FIGS. 4 and 5. In this case, the slope α and the y-intercept β are changed according to LD categories. FIG. 6 is a graph illustrating the LD's power variation varying with temperature.

As can be seen from FIG. 6, the slope α and the y-intercept β simultaneously vary with temperature. Two values are required to calculate the slope α and the y-intercept β.

Therefore, other methods are required to consider the LD's power variation varying with temperature at each sampling point. A representative method fixes one of the slope α and the y-intercept β, and calculates the other one, such that the LD's power can be obtained.

A method for fixing the slope α, calculating the y-intercept β, and calculating the LD's power varying with temperature will be described herein below.

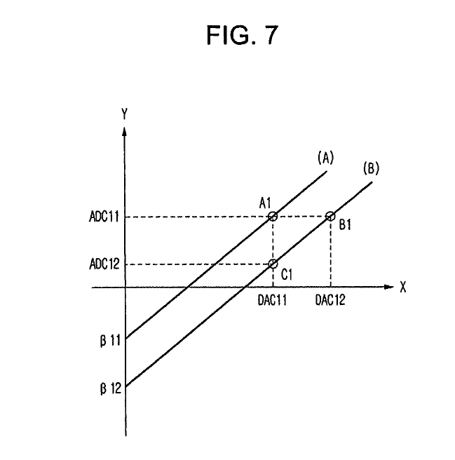

FIG. 7 is a graph illustrating a variation in the LD's power according to a variation in temperature on the condition that the slope α shown in FIG. 6 is fixed and the y-intercept β is changed. If the slope α of FIG. 6 is fixed, the variation in the LD's power varying with temperature is shown in FIG. 7.

Referring to the graph (A) of FIG. 7, if a temperature is changed at a specific point “A1” having no temperature variation, the LD power is reduced at the same DAC value, so that the LD power moves to the point “C1”. As a result, it can be recognized that the ADC value is reduced. Therefore, in order to obtain a desired ADC11's output signal, the DAC value must be changed to another value, so that it must move to the point “B1”.

In this case, the slope α and the y-intercept β12 are required to calculate the DAC12's value at the point “B1 ”, a process for calculating the above-mentioned DAC12's value is denoted by the following equations #2 to #4:
α=(ADC11+β11)/DAC11 [Equation #2]
β12=ADC11−ADC12+β11 [Equation #3]
DAC12=(2×ADC11−ADC12+β11)/α [Equation #4]

If the slope a is fixed on the basis of Equations 2 to 4, the LD's power varying with temperature can be calculated as shown in the graph (B) shown in FIG. 7.

A method for fixing the y-intercept β, calculating the slope α, and calculating the LD's power will hereinafter be described.

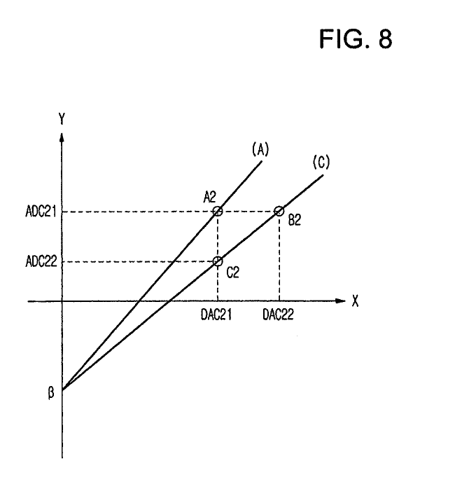

FIG. 8 is a graph illustrating a variation in the LD's power according to a variation in temperature on the condition that the y-intercept β is fixed and the slope α is changed. If the y-intercept β of FIG. 6 is fixed, the variation in the LD's power varying with temperature is shown in FIG. 8.

Referring to the graph (A) of FIG. 8, if a temperature is changed at a specific point “A2” having no temperature variation, the LD power is reduced at the same DAC value, so that the LD power moves to the point “C2”. As a result, it can be recognized that the ADC value is reduced. Therefore, in order to obtain a desired ADC21's output signal, the DAC value must be changed to another value, so that it must move to the point “B2”.

In this case, the slope α22 and the y-intercept β are required to calculate the DAC22's value at the point “B2”, a process for calculating the above-mentioned DAC22's value is denoted by the following equations #5 to #7:
α22=(ADC22+β)/DAC21 [Equation #5]
β=α21×DAC21−ADC21 [Equation #6]
DAC22=DAC21×{(ADC21+β)/(ADC22+β)} [Equation #7]

If the y-intercept β is fixed on the basis of Equations #5 to #7, the LD's power varying with temperature can be calculated as shown in the graph (C) shown in FIG. 8.

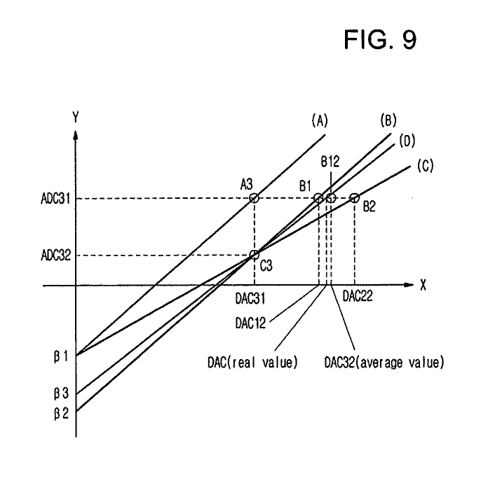

A method for calculating the LD's power using an average value of two values acquired by the above-mentioned methods of FIGS. 7 and 8 will hereinafter be described with reference to FIG. 9.

FIG. 9 is a graph illustrating a process for searching for an average value of the LD power variation according to a temperature variation acquired when one of the slope α and the y-intercept β shown in FIG. 6 is fixed. In more detail, FIG. 9 shows a variation in the LD's power using the average value of the DAC12's value calculated by the graph (B) shown in FIG. 7 and the DAC22's value calculated by the graph (C) as shown in FIG. 8.

Referring to the graph (A) shown in FIG. 9, if a temperature is changed at a specific point “A3” having no temperature variation, the LD power is reduced at the same DAC value, so that the LD power moves to the point “C3”. As a result, it can be recognized that the ADC value is reduced. Therefore, in order to obtain a desired ADC31's output signal, the DAC value must be changed to another value, so that it must move to the point “B1” or the point “B2”.

In this case, the DAC12's value and the DAC22's value are required to calculate an average value (i.e., the DAC32's value) at the point B1 or B2, and the DAC12's value and the DAC22's value are calculated by the methods shown in FIGS. 7 and 8, such that a process for calculating the DAC32's value is denoted by the following equation #8:
DAC32=(DAC12+DAC22)/2 [Equation #8]

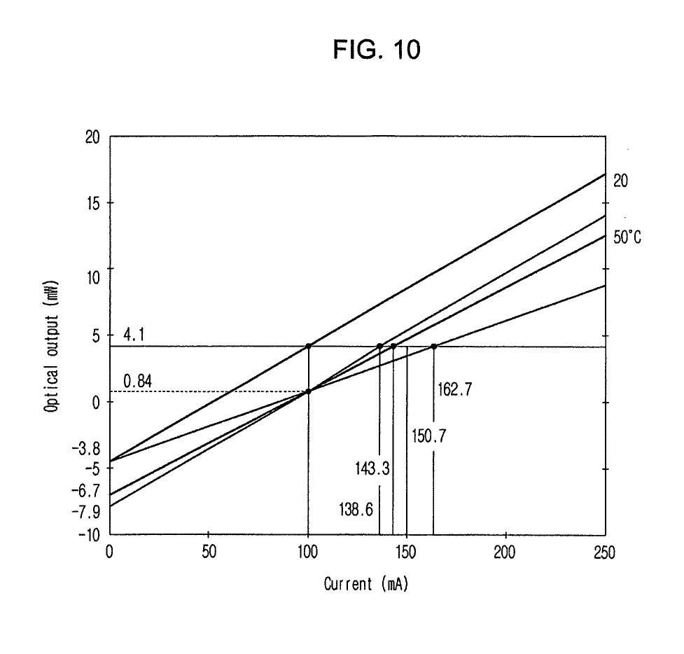

If the ADC12's value calculated by Equation #4, the ADC22's value calculated by Equation #7, and the real calculated values are indicated on the graph, the graph shown in FIG. 9 can be acquired. Otherwise, the simulation result of the ADC12's value, the ADC22's value, and the real calculated values is shown in FIG. 10.

In conclusion, three methods shown in FIGS. 7 to 9 are used to calculate desired DAC values. As can be seen from the simulation result of FIG. 10, the method for fixing the slope α, calculating the y-intercept β, and calculating the LD's power has the highest accuracy. In this case, a user may properly select one of the three methods according to LD's characteristics.

In this way, the value calculated by the compensator 50 is converted into an analog signal via the DAC 60A-60C, as shown in FIG. 2, and the calculated value is transmitted to the LD drive 70, such that the LD's power is adjusted. In this case, the DAC value is converted into a DAC value suitable for the power level calculated by the compensator 50 for compensating for a sampling moment.

As is apparent from the above description, an apparatus and method for controlling the power of the laser diode according to the present invention compensates for the LD power at a sampling moment so as to constantly maintain the LD's power varying with temperature, such that it can effectively implement the ALPC function within a short period of time as compared to the LD power compensation method implemented by a conventional counter.

The apparatus and method for controlling the power of the laser diode according to the present invention compensates for a desired power level during a sampling operation, and quickly copes with a variation in the LD's power varying with temperature, such that it can acquire an accurate power level.

Various components of the power control device, as shown in FIG. 2, such as the IV converter 30, the ADC 40, the compensator 50 and the DAC 60 can be integrated into a single control unit 170, or alternatively, can be implemented in software or hardware, such as, for example, an application specific integrated circuit (ASIC). As such, it is intended that the processes described herein be broadly interpreted as being equivalently performed by software, hardware, or a combination thereof. As previously discussed, software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

In addition, the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, other sources of laser beam can be used in substitution of a laser diode. Moreover, alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Furthermore, the software modules as described can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

What is claimed is:

1. An apparatus for controlling power of a laser diode (LD) used for an optical recording apparatus to record data in an optical recording device comprising:
a compensator for sampling a power of a laser diode (LD) generated when data is recorded, and compensating for a variation of the power of the laser diode (LD) varying with temperature; and
a driver for driving the laser diode (LD) to record data in the optical recording device.

2. The apparatus according to claim 1, wherein the compensator compensates for the power of the laser diode (LD) varying with temperature at a sampling moment.

3. The apparatus according to claim 2, wherein the compensator samples a first point at which the power of the laser diode (LD) is maintained during a predetermined time or over and a second point at which the power of the laser diode (LD) is maintained during a time shorter than the predetermined time, such that a difference in power level is compensated according to sampling locations.

4. The apparatus according to claim 1, wherein the compensator numerically indicates output characteristics of the laser diode (LD) varying with temperature in the form of a linear function, calculates the power of the laser diode (LD), and compensates for a difference in power level at each sampling moment on the basis of the calculated power of the laser diode (LD).

5. The apparatus according to claim 4, wherein the compensator fixes one of a slope and a y-intercept of a numerical linear function, changes the one other than the fixed one, and calculates the power of the laser diode (LD).

6. The apparatus according to claim 5, wherein the compensator fixes one of a slope and a y-intercept of a numerical linear function, changes the one other than the fixed one, calculates two values, and calculates the power of the laser diode (LD) using an average value of the two values.

7. A method for controlling power of a laser diode (LD) used for an optical recording apparatus to record data in an optical recording device comprising:
a) sampling the power of the laser diode (LD) generated when data is recorded; and
b) compensating for a variation of the power of the laser diode (LD) changed according to sampling locations.

8. The method according to claim 7, wherein the sampling (a) of the power of the laser diode (LD) includes sampling a first point at which the power of the laser diode (LD) is maintained during a predetermined time and a second point at which the power of the laser diode (LD) is maintained during a time shorter than the predetermined time.

9. The method according to claim 7, wherein the compensating (b) of the power of the laser diode (LD) includes compensating for the power of the laser diode (LD) varying with temperature at a sampling moment.

10. The method according to claim 7, wherein the compensating (b) of the power of the laser diode (LD) includes:
b1) numerically indicating output characteristics of the laser diode (LD) varying with temperature in the form of a linear function;
b2) calculating the power of the laser diode (LD) varying with temperature on the basis of the numerical linear function; and
b3) compensating for a difference in power level at each sampling moment on the basis of the calculated power.

11. The method according to claim 10, wherein the calculating (b2) of the power of the laser diode (LD) includes:
fixing a slope of the numeral linear function;
changing only a y-intercept; and
calculating the power of the laser diode (LD).

12. The method according to claim 10, wherein the calculating (b2) of the power of the laser diode (LD) includes:
fixing a y-intercept of the numeral linear function;
changing only a slope; and
calculating the power of the laser diode (LD).

13. The method according to claim 10, wherein the calculating (b2) of the power of the laser diode (LD) includes:
fixing one of a slope and a y-intercept of the numerical linear function;
changing the one other than the fixed one;
calculating two values; and
calculating the power of the laser diode (LD) using an average value of the two values.

14. An apparatus for controlling a laser source used to record data on a recording medium comprising:
a pickup unit provided with a laser source for emitting an optical signal having a recording power to record data on a recording medium, and a photo-detector for detecting the recording power of the optical signal emitted from the laser source;
a compensator arranged to compensate for variations in the recording power of the optical signal when data is recorded on the recording medium, based on the detected recording power of the optical signal emitted from the laser source, and to maintain the recording power at an optimum level irrespective of variations in temperature; and
a drive unit arranged to operate the laser source included in the pickup unit to record data on the recording medium.

15. The apparatus according to claim 14, wherein the laser source is a laser diode (LD).

16. The apparatus according to claim 15, wherein the compensator compensates for the recording power of the laser diode (LD) varying with temperature at a sampling moment.

17. The apparatus according to claim 16, wherein the compensator samples a first point at which the recording power of the laser diode (LD) is maintained during a predetermined time and a second point at which the recording power of the laser diode (LD) is maintained during a time shorter than the predetermined time, such that a difference in power level is compensated according to sampling locations.

18. The apparatus according to claim 16, wherein the compensator numerically indicates output characteristics of the laser diode (LD) varying with temperature in the form of a linear function, calculates the recording power of the laser diode (LD), and compensates for a difference in power level at each sampling moment on the basis of the calculated power of the laser diode (LD).

19. The apparatus according to claim 18, wherein the compensator fixes one of a slope and a y-intercept of a numerical linear function, changes the one other than the fixed one, and calculates the power of the laser diode (LD).

20. The apparatus according to claim 18, wherein the compensator fixes one of a slope and a y-intercept of a numerical linear function, changes the one other than the fixed one, calculates two values, and calculates the power of the laser diode (LD) using an average value of the two values.
